(19) United States
(12) Patent Application Publication
(10) Pub. No.: US 2005/0077251 A1
(43) Pub. Date: Apr. 14, 2005

(54) Method for control of wastewater treatment plant odors

(76) Inventors: Michael G. Rieth, Woodbury, MN (US); Claude T. Anderson, Arden Hills, MN (US)

Correspondence Address: CLAUDE ANDERSON, 1758 Venus Ave, Arden Hills, MN, 55112, US

(21) Appl. No.: 10/960,132

(22) Filed: Oct. 7, 2004

Related U.S. Application Data
(60) Provisional application No. 60/509,721, filed on Oct. 8, 2003.

(51) Int. Cl. C02F 1/72

(52) U.S. Cl. 210/758; 210/916

(57) ABSTRACT

The invention consists of a process to cost-effectively reduce or eliminate odors from wastewater treatment plant processes. The invention discloses the recycling of a portion of a wastewater treatment plant nitrified effluent, utilizing the dissolved oxygen and nitrate in the effluent to prevent the formation or reduce levels of sulfides and odourous organics in primary clarifiers. The process can be supplemented with conventional chemical treatment such as nitrate addition, and other process recycle streams such as incinerator scrubber water may also be used.

### CROSS-REFERENCE TO RELATED APPLICATIONS

This application claims the benefit of the filing date of U.S. Provisional Application No. 60/509,721, filed Oct. 8, 2003, incorporated herein by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

Odor problems at wastewater treatment plants are a common concern. These odors are often caused by hydrogen sulfide, sulfur containing organic compounds and various other organic compounds. Wastewater may contain odorous chemicals discharged into the sewage system. Often the odorous compounds are generated from septic conditions in the wastewater. Wastewater contains large quantities of easily biodegradable organics. As these organics decompose, any oxygen in wastewater is used for bacterial respiration and the wastewater becomes anoxic or anaerobic, allowing the formation of hydrogen sulfide, sulfur containing organic compounds and various other organic compounds. The facilities such as clarifiers or settling tanks associated with holding wastewater treatment plant often provide conditions favorable to odor generation and are therefor often a source of odor problems that must be addressed.

The processes associated with wastewater treatment are often categorized into preliminary, primary, secondary or tertiary wastewater treatment processes. In addition, there are also treatment processes associated with processing the solids obtained from the wastewater and for treating the off-gases generated in the treatment processes.

Preliminary treatment includes the screening and grit removal of the raw wastewater entering a wastewater treatment plant. The purpose of these treatment processes is to remove large sticks, rocks, rags and other coarse materials that may harm downstream process equipment.

Following preliminary treatment is primary treatment where flotable and settleable solids in the wastewater are separated from the liquid. Screens, primary clarifiers, and skimming devices are most commonly used for the separation.

After primary treatment, wastewater enters a biological treatment process known as secondary treatment to remove up to 80 or 90 percent of the dissolved organic pollutants.

Some treatment plants require nutrient removal, which is considered tertiary or advanced secondary treatment. Wastewater treatment plant effluent from an advanced secondary treatment plant is often characterized by effluents containing oxidants such as nitrate and dissolved oxygen.

The sludge generated in wastewater treatment plants may be processed in a variety of ways such as landfilling, land application or incineration. If sludge incineration is used, the incineration process is generally followed by air pollution control equipment which may include wet air scrubbers. Wet air scrubbers contact the incinerator exhaust gases with water to reduce the gas temperature and remove pollutants. These pollutants include a variety of metals such as iron, lead, cadmium, zinc and nickel which can react with sulfides, as well as oxidized compounds such as nitrate and oxygen. The hydraulic flows and the metal concentrations associated with the air pollution control equipment can be fairly significant.

Odor removal is typically achieved by either collecting off-gases from the various treatment processes and then treating these off-gases, or adding chemicals to the wastewater to react with the odor causing compounds. Conventional chemicals that are known to provide for sulfide removal generally, will also generally remove sulfides from wastewater.

Hypochlorite (sodium or calcium), potassium permanganate, sodium nitrate, ferrous and ferric chloride, ferrous sulfate, hydrogen peroxide, chlorine, chlorine dioxide, and sodium chlorite have been widely used for the control of odor in wastes, and sewage waste in particular. For example, U.S. Pat. No. 6,059,973 describes the addition of nitate ions and microbes to wastewater to reduce hydrogen sulfide levels. U.S. Pat. No. 4,911,843 by Hunniford et al. describes the addition of nitrate to sewers to reduce hydrogen sulfide levels. U.S. patent application Ser. No. 2003/0062322 by Walton et al. describes the addition of hydrogen peroxide and iron salts to reduce the hydrogen sulfide levels in sewage. U.S. Pat. No. 6,284,138 by Mast describes the addition of oxygen or ozone to sewage to remove hydrogen sulfide. U.S. Pat. No. 6,309,597 by Ballinger describes a method for reducing the hydrogen sulfide level in water using metallic nitrogen oxides and polycyclic quinones. U.S. Pat. No. 5,984,993, by Mainz, et al. describes a method for controlling waste product odors with a combination of chlorite and nitrate salts.

However, at municipal wastewater treatment plants, continuous chemical addition is often extremely expensive due to the large volumes of domestic waste that must be treated.

The invention consists of a wastewater treatment plant where a nitrified effluent or effluent-based recycle flow such as incinerator scrubber water, either directly or indirectly upstream of a wastewater primary treatment process. Furthermore, the flow can be spiked with a chemical nitrate source, e.g. calcium nitrate, to handle peak flow or peak generation periods. This can reduce the amount of nitrate recycle flow required during hydraulic peaking events.

It is an object of the invention to utilize a recycle flow to provide a relatively large amount of nitrates to inhibit sulfide generation and reduce wastewater treatment process odors at minimal cost, e.g. piping and pumping.

It is an object of the invention to provide sulfide inhibition for a wastewater treatment plant to avoid the cost of cost covering the tank surfaces, effluent weirs or both and treating the emitted sulfides in a downstream process.

It is an object of the invention to provide sulfide inhibition to reduce the cost of operating and maintaining the downstream sulfide removal process(es), e.g. less chemical requirements, less frequent media changeouts.

It is an object of the invention to allow supplementing the recycle flow with a spike addition of a chemical to allow the process to operate during hydraulic peaks if the plant is currently at its hydraulic peaking capacity.

It is an object of the invention to allow supplementing the recycle flow with a spike addition of a chemical to allow the process to meet excessive peaks in sulfide generation that may appear seasonally or diurnally.

### BRIEF SUMMARY OF THE INVENTION

This invention discloses a method to reduce chemical costs for odor treatment at a wastewater treatment plant. Hydrogen sulfide and other reduced sulfide compounds are prevented from being formed or removed by the recirculation of wastewater effluents or other recycle streams within the wastewater treatment plant upstream of wastewater treatment processes such as primary clarifiers that generate these odors.

### BRIEF DESCRIPTION OF THE SEVERAL VIEWS OF THE DRAWINGS

FIG. 1 Invention Method Schematic Flow Diagram

FIG. 2 Suppression of Primary Clarifier Sulfide Generation Using Nitrate Recycle

FIG. 3 Suppression of Primary Clarifier Sulfide Generation Using Nitrate Recycle

FIG. 4 Sulfide Generation along the Length of Wastewater Treatment Plant Primary Clarifiers

FIG. 5 Nitrate Addition to Inhibit Hydrogen Sulfide Generation In Primary Clarifiers

FIG. 6 Hydrogen Sulfide Profile—Primary Clarifier No. 9—Nitrate Added

FIG. 7 Air Monitoring in Primary Effluent Weirs during Nitrate Addition

FIG. 8 Effluent Recirculation for Nitrate Addition to 200 Mgd Primary Clarifier Flow

FIG. 9 DO levels in a Wastewater Treatment Plant Primary Effluent Channel

FIG. 10 Effect of Discharge Pressure on Pumping Costs—18 Mgd

FIG. 11 Costs of Effluent Recirculation for Sulfide Control

### DETAILED DESCRIPTION OF THE INVENTION

Wastewater entering a wastewater treatment plant first undergoes preliminary treatment which typically consists of screening and grit removal. The purpose of these treatment processes is to remove sand, large sticks, rocks, rags and other coarse materials that may harm downstream process equipment.

Following preliminary treatment, wastewater generally receives primary treatment. In primary treatment flotable and settleable solids in the wastewater are separated from the liquid. Screens, settling tanks or clarifiers, and skimming devices are most commonly used for the separation. Primary treatment removes settleable solids and is not intended to remove dissolved pollutants, however, it does remove 45 to 50 percent of the incoming pollutants. With the high organic loading, the long detention times, and the lack of an oxygen source, the wastewater often becomes septic and primary treatment tanks are often a large source for odor generation.

After primary treatment, wastewater enters a second stage of treatment known as secondary treatment to remove dissolved pollutants, up to 80 or 90 percent altogether.

For economic considerations, secondary treatment is typically a biological process. Air is supplied to stimulate the growth of bacteria and other organisms to consume most of the carbonaceous waste materials. The wastewater is then separated from the organisms and solids, disinfected to reduce any remaining harmful bacteria, and released to a nearby lake, river or stream.

Increasingly wastewater treatment plant effluent regulatory requirements demand nutrient removal in addition to conventional carbonaceous removal. Nutrient removal, might include requirements to limit phosphorus, ammonia or total nitrogen discharges. These compounds can be removed either simultaneously with the carbonaceous compounds, or in a treatment process separate from secondary treatment. Generally, nutrient removal is considered tertiary or advanced secondary treatment. In addition to nutrient removal, wastewater treatment plant effluent from an advanced secondary treatment plant is often characterized by effluents or intermediate recycle streams with nitrate present as a component and a high dissolved oxygen component.

The sludge generated in wastewater treatment plants may be processed in a variety of ways such as landfilling, land application or incineration. If sludge incineration is used, the incineration process is generally followed by air pollution control equipment which may include wet air scrubbers. Wet air scrubbers contact the incinerator exhaust gases with water to reduce the gas temperature and remove pollutants. These pollutants include a variety of metals which can precipitate sulfides such as iron, lead, cadmium, zinc and nickel. Recycle flows from the incinerator pollution control processes may also contain high levels of oxidants such as dissolved oxygen as well as some nitrate. The process wastewater flows and the metal concentrations associated with the air pollution control equipment can be fairly significant.

Wastewater treatment plant processes, particularly primary treatment processes are characterized with high organic loading and low dissolved oxygen levels, resulting in anearobic or anoxic conditions that allow hydrogen sulfide formation. Due to the low solubility of hydrogen sulfide, it tends to transfer from the liquid wastewater to the atmosphere resulting in odor problems.

Typical odor control measures include; 1) Adding oxidants such as nitrates or dissolved oxygen to prevent septic conditions so that sulfides are not formed, 2) Adding chemicals to oxidize or precipitate the sulfides that are present or may form, or 3) collecting off-gases from the various treatment processes and then treating these off-gases with various gas-phase treatment technologies.

Conventional chemicals that are known to provide for sulfide removal generally, will also generally remove sulfides from wastewater. Oxidants such as hypochlorite (sodium or calcium), potassium permanganate, sodium nitrate, ferrous sulfate, hydrogen peroxide, chlorine, chlorine dioxide, and sodium chlorite, or iron salts such as ferrous and ferric chloride, have been widely used for the control of odor in wastes, and sewage waste in particular

However, at municipal wastewater treatment plants, chemical addition is often extremely expensive due to the large volumes of domestic waste that must be treated. For example, a wastewater treatment plant serving a population of 1 million, might treat 100 million gallons of day of wastewater. If the wastewater contained 1 mg/l of sulfide, that would be 834 lbs of sulfide per day that must be treated. With conventional chemical treatment technology, a chemical cost of over $1,000/day could be expected.

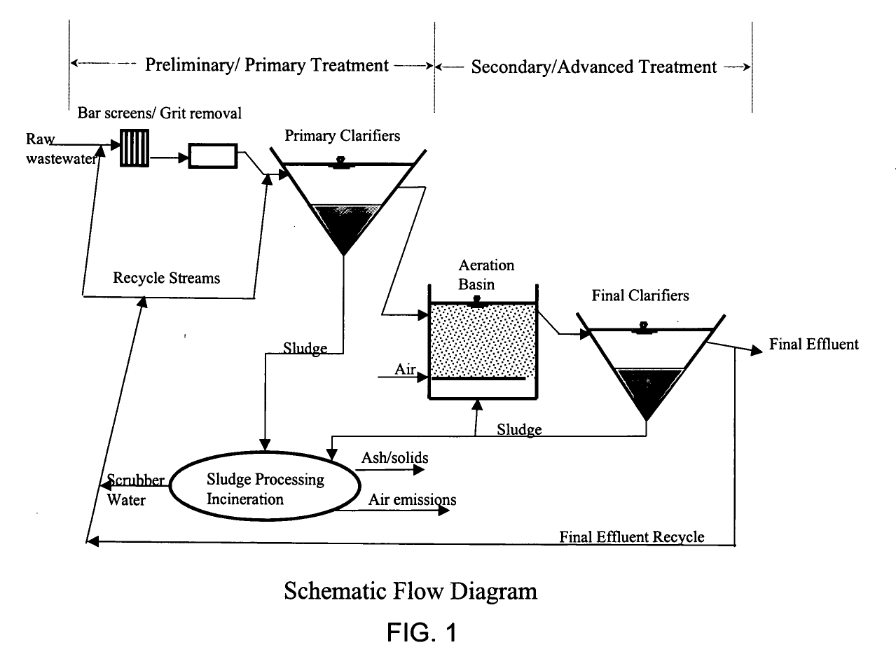

As shown in FIG. 1. The invention consists of a wastewater treatment plant where:

1. Inject a nitrified effluent or a recycle flow, such as incinerator scrubber water, either directly or indirectly upstream of a wastewater treatment process such as a primary clarifier.

2. Furthermore, the wastewater flow can be dosed with a chemical nitrate source, e.g. calcium nitrate or sodium nitrate, to handle peak flow or peak generation periods. This reduces (or can even eliminate) the amount of nitrate recycle flow required during hydraulic peaking events, while minimizing chemical costs.

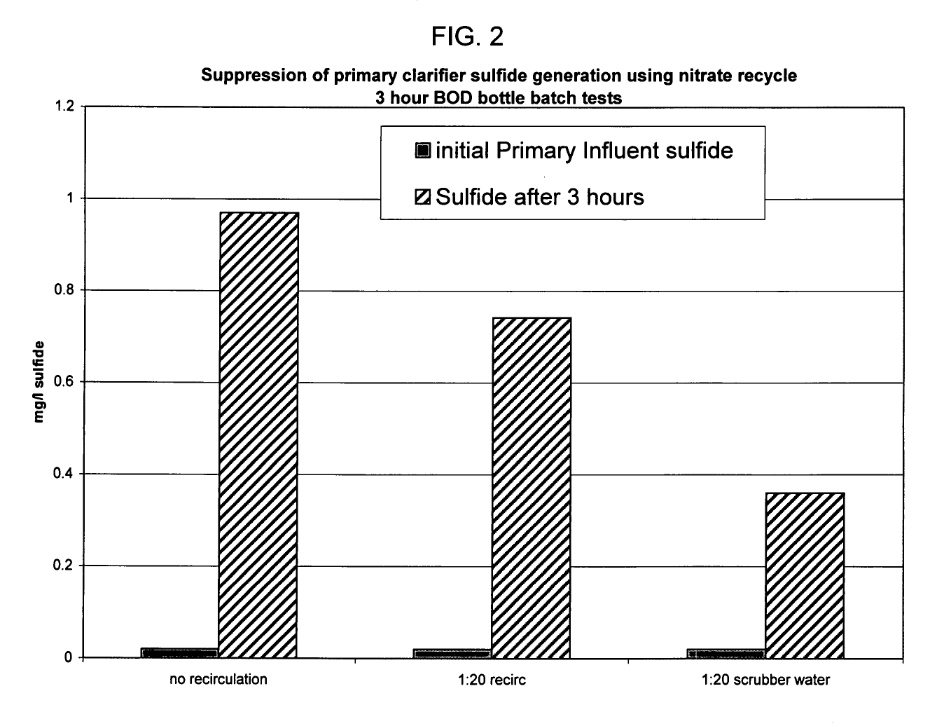

Shown in FIG. 2 is the results of batch tests using incinerator scrubber water and nitrified effluent showing the suppression of primary clarifier sulfide generation using nitrate recycle and incinerator scrubber water after a 3-hour period.

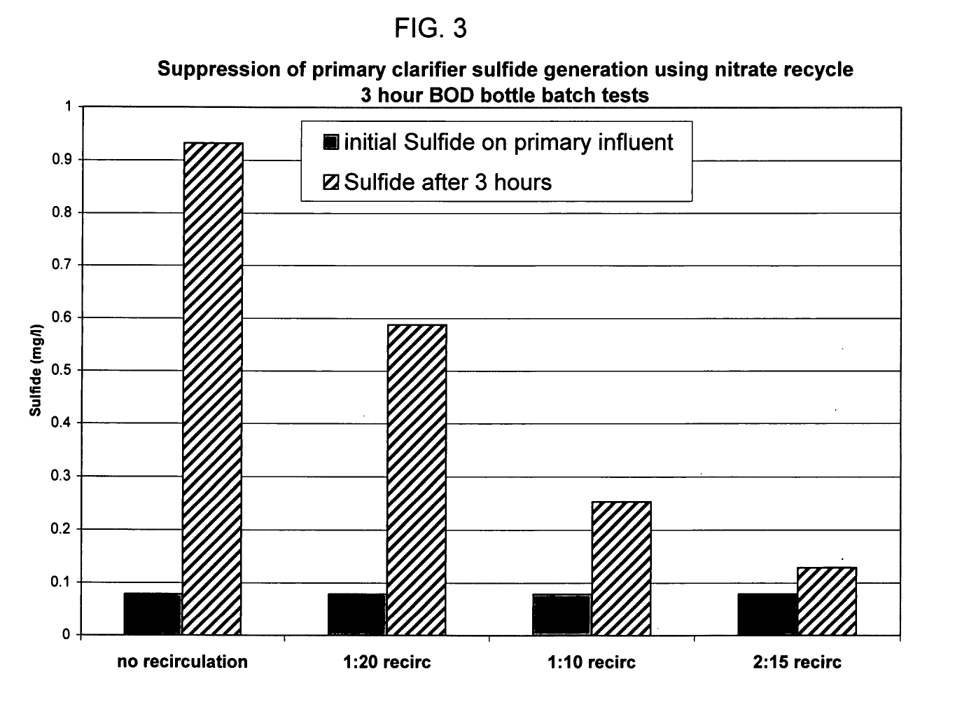

FIG. 3 shows the suppression of primary clarifier sulfide generation using nitrate recycle with various ratios of nitrified effluent

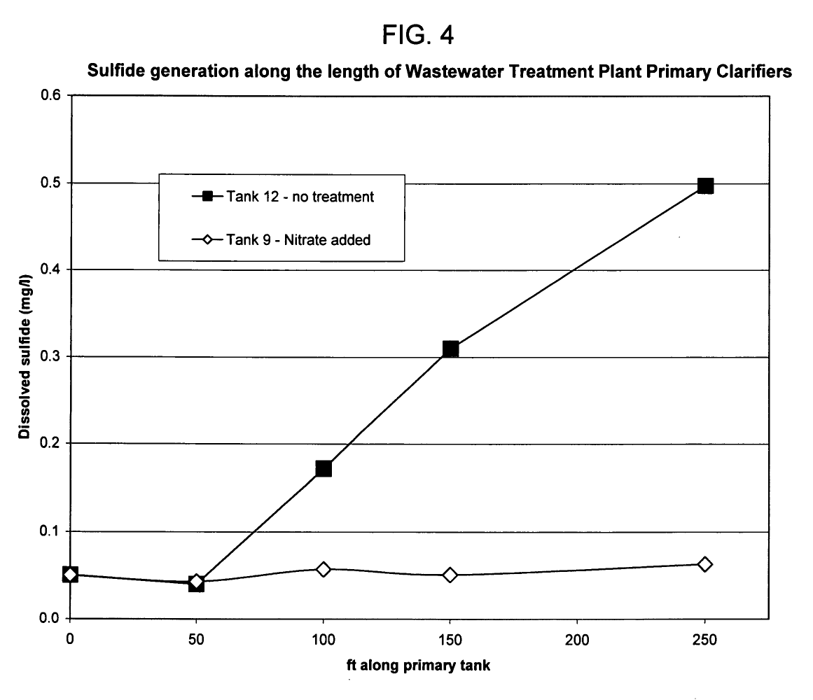

Shown in FIG. 4 is the suppression of sulfide generation along the length of a primary clarifier when nitrate is added.

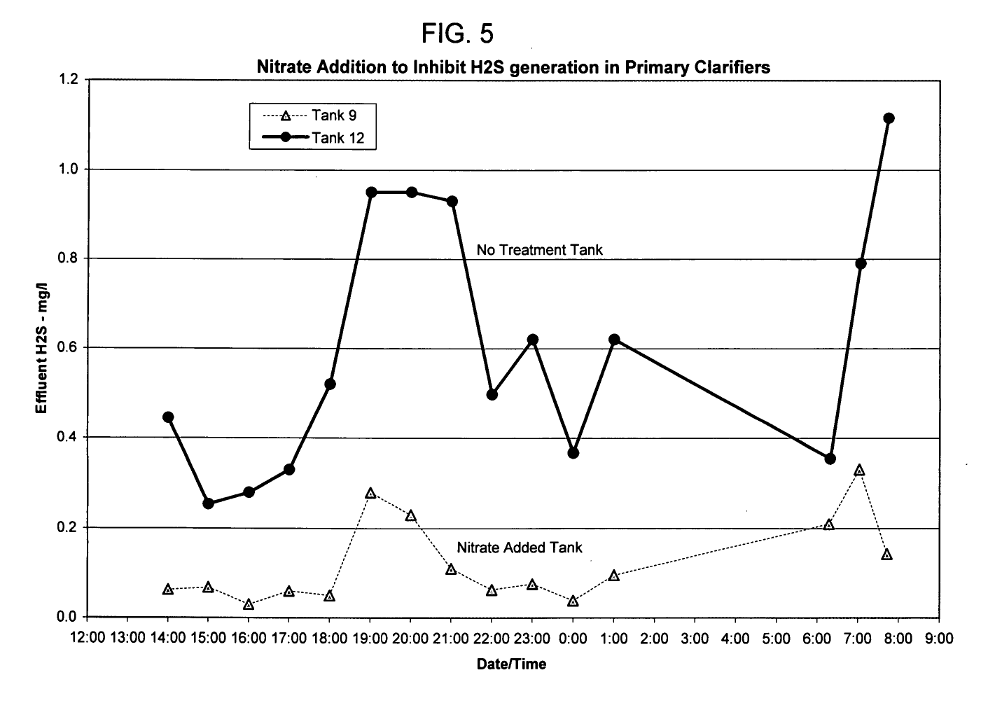

A time series plot is shown in FIG. 5 of the effect of nitrate addition to inhibit hydrogen sulfide generation in primary clarifiers.

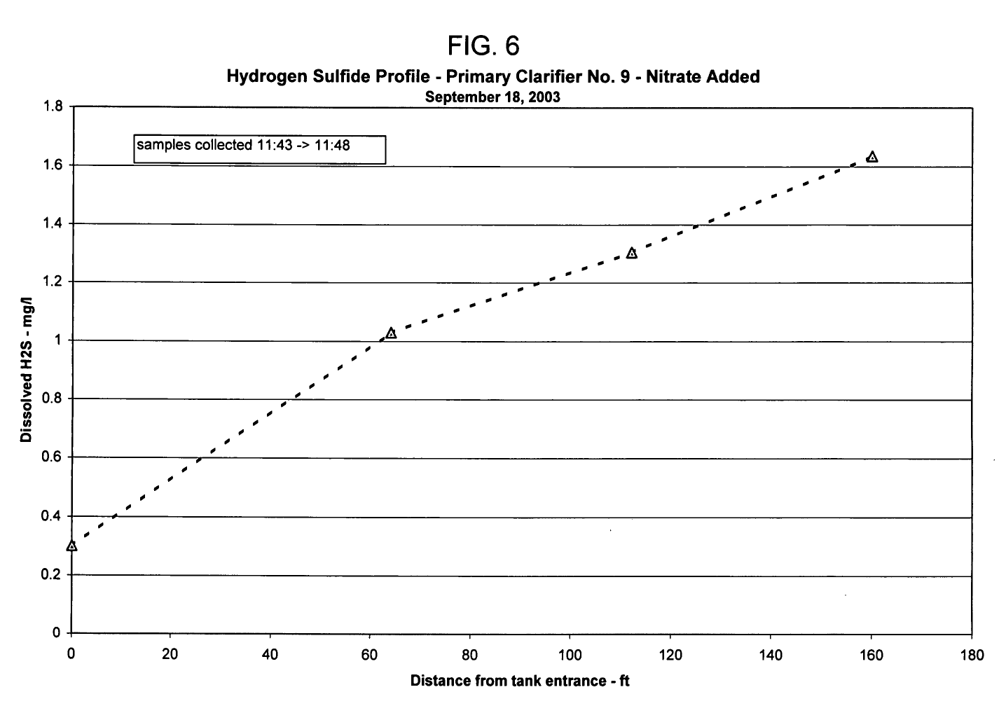

In FIG. 6 is a hydrogen sulfide profile for a primary clarifier not receiving any nitrate addition.

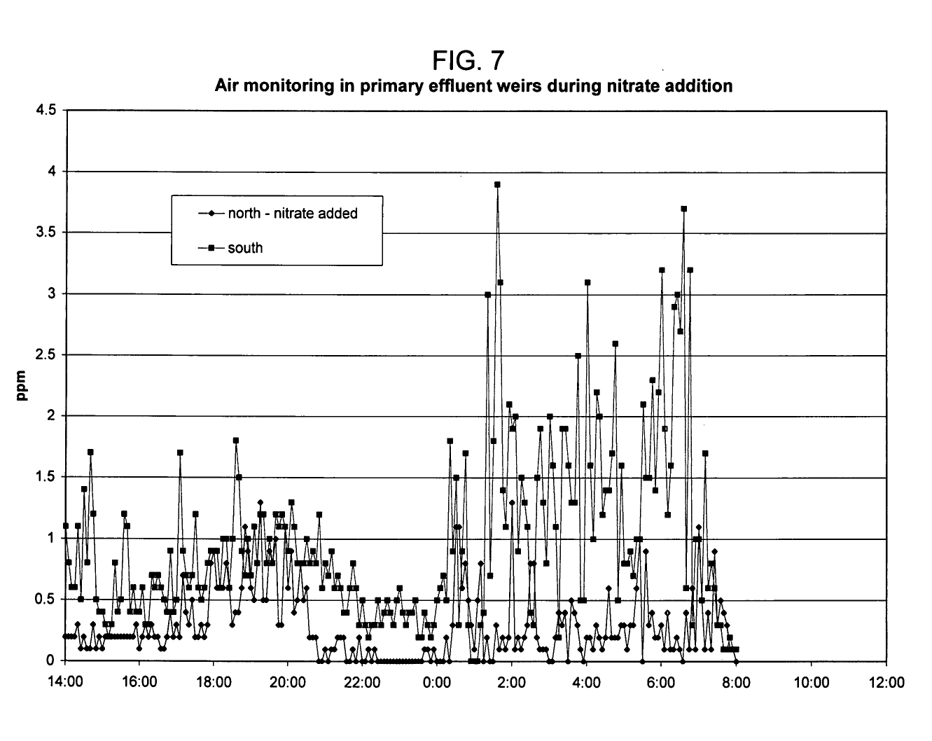

FIG. 7 shows the air phase hydrogen sulfide levels at the primary clarifier effluent weirs with and without nitrate addition.

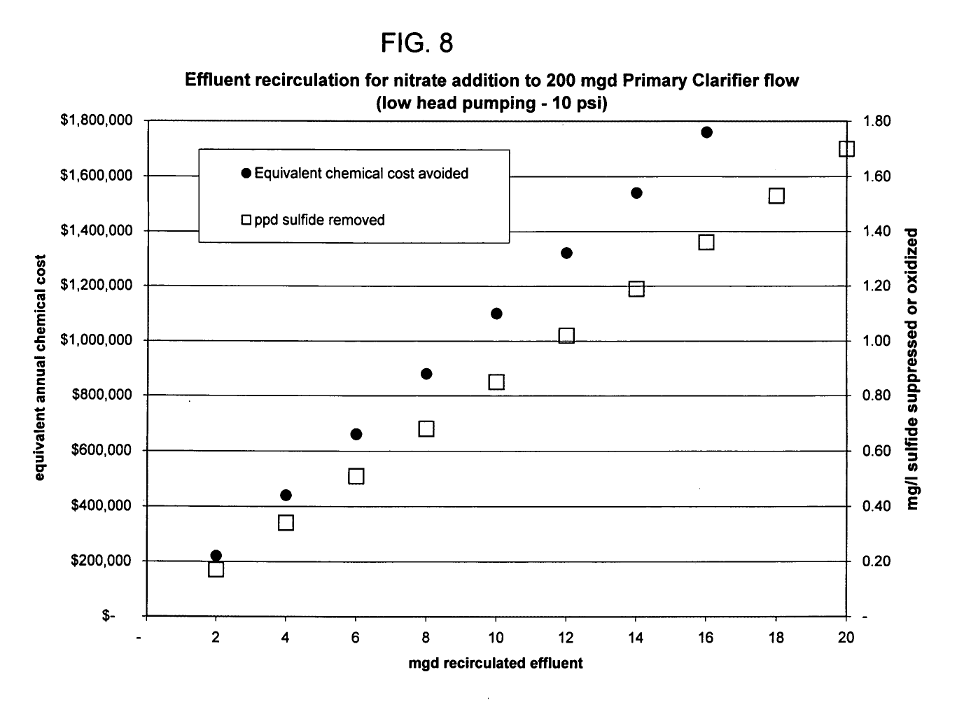

FIG. 8 compares the cost of effluent recirculation with the amount of sulfide generation suppressed or removed for various levels of effluent recirculation.

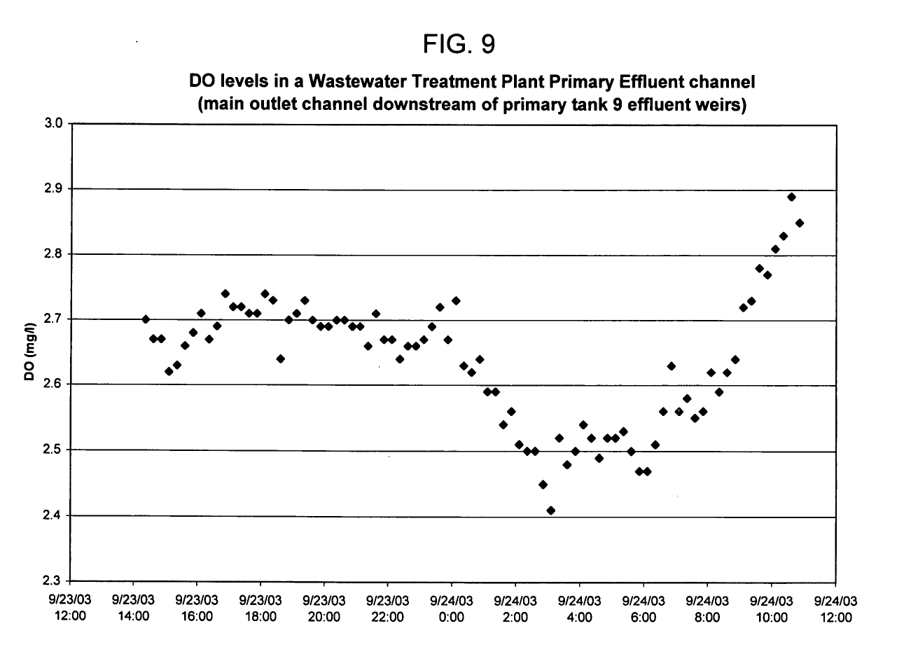

FIG. 9 shows the dissolved oxygen levels downstream of the primary clarifier effluent weirs when nitrate is not being added.

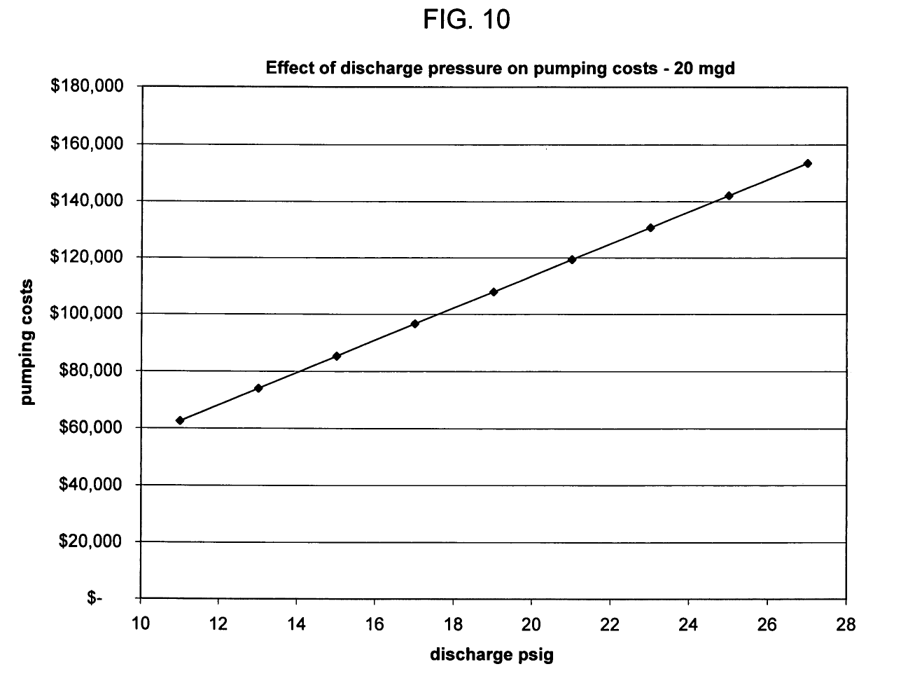

In FIG. 10 the relationship between discharge pressure an pumping costs for the recirculated effluent is shown.

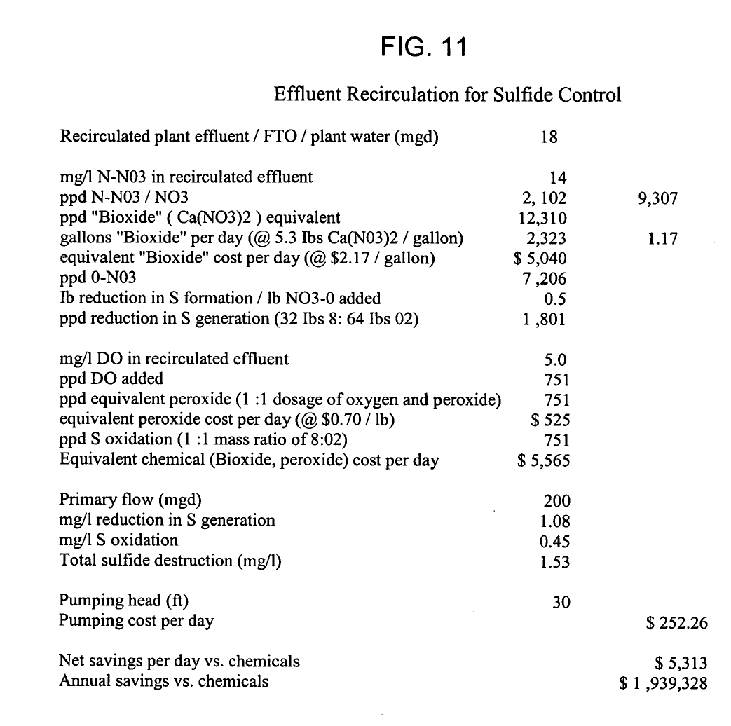

FIG. 11 provides a comparison of the costs for sulfide control with and without effluent recirculation.

1. A process to inhibit the formation of hydrogen sulfide at a wastewater treatment plant comprising;
adding a recycle flow from the wastewater treatment plant upstream of a wastewater treatment process,
the recycle flow containing an oxidant.

2. A process to inhibit the fonnation of hydrogen sulfide at a wastewater treatment plant comprising;
adding a recycle flow from the wastewater treatment plant upstream of a primary clarifier,
the recycle flow containing an oxidant.

3. A process to inhibit the formation of hydrogen sulfide at a wastewater treatment plant comprising;
adding a recycle flow includes a nitrate compound from the wastewater treatment plant upstream of a primary clarifier.

4. The process of claim 1 wherein the oxidant includes a dissolved oxygen component. The process of claim 2 wherein the recycle flow is a secondary effluent.

5. The process of claim 2 wherein the recycle flow is a wastewater treatment plant effluent.

6. The process of claim 2 wherein the recycle flow is an incinerator scrubber water.

7. The process of claim 3 wherein the recycle flow is a secondary effluent.

8. The process of claim 3 wherein the recycle flow is a wastewater treatment plant effluent.

9. The process of claim 3 wherein the recycle flow is an incinerator scrubber water.

10. The process of claim 1 further comprising an iron salt is supplementally added upstream of the wastewater treatment process.

11. The process of claim 1 further comprising a nitrate compound is supplementally added upstream of the wastewater treatment process.

12. The process of claim 1 further comprising a dissolved oxygen component is supplementally added upstream of the wastewater treatment process.

13. The process of claim 2 further comprising an iron salt is supplementally added upstream of the primary clarifier.

14. The process of claim 2 further comprising a nitrate compound is supplementally added upstream of the primary clarifier.

15. The process of claim 2 further comprising a dissolved oxygen component is supplementally added upstream of the primary clarifier.
